(19) United States
(12) Patent Application Publication
(10) Pub. No.: US 2025/0229851 A1
(43) Pub. Date: Jul. 17, 2025

(54) AUTONOMOUS TRACTOR-TRAILER

(71) Applicants: Chad BURCHETT, Browns Summit, NC (US); VOLVO TRUCK CORPORATION, Göteborg (DE)

(72) Inventor: Chad BURCHETT, Browns Summit, NC (US)

(73) Assignee: VOLVO TRUCK CORPORATION, Göteborg (DE)

(21) Appl. No.: 18/844,806

(22) PCT Filed: Mar. 7, 2022
(86) PCT No.: PCT/US2022/019173

§ 371 Date: Sep. 6, 2024

(51) Int. Cl. B62D 49/00; B62D 53/08

(52) U.S. Cl. CPC B62D 49/007; B62D 53/08

(57) ABSTRACT

Articulated vehicles and trailers configured for highway transportation, where the tractor of the articulated vehicle is configured to operate in an autonomous mode. In such articulated vehicles, the trailer can be removably coupled to the tractor via a kingpin. The tractor, when coupled to the trailer via the kingpin, and aligned with the trailer, fits entirely beneath the trailer, the tractor being operable to tow the trailer when coupled to the trailer.

### BACKGROUND

### 1. Technical Field

The present disclosure relates to an autonomous tractor-trailer, and more specifically to an articulated vehicle where the tractor can fit entirely beneath the trailer while coupled for over the highway travel, resulting in a more maneuverable tractor-trailer vehicle.

### 2. Introduction

The trucking industry relies on the use of articulated vehicles, which have a permanent or semi-permanent pivot joint, allowing the vehicle to make turns more sharply. These articulated vehicles often rely on a tractor (the front part which pulls) and one or more rear parts (the trailer). The semi-permanent pivot joint uses a nipple at the front of a trailer which connects to a fifth wheel coupling on the tractor, the fifth wheel coupling on the trailer also known as a “kingpin.”

Autonomous technology for articulated vehicles currently relies on an autonomous tractor pulling a conventional trailer. However, current trailers for autonomous articulated vehicles are configured so that they can be pulled manually driven tractors, resulting in less-than optimal maneuverability.

### SUMMARY

Additional features and advantages of the disclosure will be set forth in the description that follows, and in part will be understood from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Disclosed are systems, methods, and non-transitory computer-readable storage media which provide a technical solution to the technical problem described. An articulated vehicle configured as described herein can include: a tractor configured to operate in an autonomous mode; and a trailer removably coupled to the tractor, wherein: the trailer has a kingpin for coupling to the tractor; the tractor, when coupled to the trailer via the kingpin, and aligned with the trailer, fits entirely beneath the trailer; and the tractor is operable to tow the trailer when removably coupled to the trailer.

A trailer configured as disclosed herein can include: a kingpin for coupling to a tractor; and at least one pair of wheels; wherein: the tractor, when coupled to the trailer via the kingpin, and aligned with the trailer, fits entirely beneath the trailer; and the tractor is operable for over the highway towing of the trailer when removably coupled to the trailer.

### ASPECTS OF THE DISCLOSURE

According to an aspect, an articulated vehicle comprises a tractor configured to operate in an autonomous mode; and a trailer removably coupled to the tractor, wherein: the trailer has a kingpin for coupling to the tractor; the tractor, when coupled to the trailer via the kingpin, and aligned with the trailer, fits entirely beneath the trailer; and the tractor is operable to tow the trailer when removably coupled to the trailer.

According to an aspect, the tractor is configured to tow the trailer when facing in a forward direction and when facing in a rearward direction.

According to an aspect, a pneumatic connection is between the tractor and the trailer, the pneumatic connection allowing the tractor to control air brakes of the trailer.

According to an aspect, pneumatic connection comprising a retractable air cable which maintains a predetermined range of slack.

According to an aspect, the trailer comprises a first pair of parallel sides and a second pair of parallel sides, the first pair of parallel sides each respectively at a right angle to the second pair of parallel sides; tires of the trailer are aligned with the second pair of parallel sides; the trailer comprises the kingpin and at least one additional kingpin; the additional kingpin is located along a centerline of the trailer at either 30 inches (76.2 cm) or 36 inches (91.44 cm) from a first edge of the first pair of parallel sides; and the kingpin is located along the centerline of the trailer at a location between the additional kingpin and the second edge of the first pair of parallel sides.

According to an aspect, the trailer comprises foldable support legs which, when coupled to the tractor, the tractor controls, such that during coupling of the tractor and the trailer the tractor commands the foldable support legs to a raised position, and upon completing operation the tractor commands the foldable support legs to a lowered position.

According to an aspect, during the coupling of the tractor and the trailer, the tractor raises suspension of the trailer.

According to an aspect, the trailer comprises an air compressor which provides air to air brakes of the trailer; and the tractor controls operation of the air compressor.

According to an aspect, the tractor controls operation of the air compressor via wireless communications.

According to an aspect, the trailer comprises a plurality of coupled trailers, wherein the tractor is physically coupled to a first trailer within the plurality of coupled trailers.

According to an aspect, the tractor is operable for highway towing of the trailer when removably coupled to the trailer.

According to an aspect, a trailer, comprises a kingpin for coupling to a tractor; and at least one pair of wheels; wherein: the tractor, when coupled to the trailer via the kingpin, and aligned with the trailer, fits entirely beneath the trailer; and the tractor is operable for over the highway towing of the trailer when removably coupled to the trailer.

According to an aspect, the tractor is configured to tow the trailer when facing in a forward direction and when facing in a rearward direction.

According to an aspect, a pneumatic connection is between the tractor and the trailer, the pneumatic connection allowing the tractor to control air brakes of the trailer.

According to an aspect, the pneumatic connection comprising a retractable air cable which maintains a predetermined range of slack.

According to an aspect, the trailer comprises a first pair of parallel sides and a second pair of parallel sides, the first pair of parallel sides each respectively at a right angle to the second pair of parallel sides; the at least one pair of wheels are aligned with the second pair of parallel sides; the trailer comprises the kingpin and at least one additional kingpin; the additional kingpin is located along a centerline of the trailer at either 30 inches (76.2 cm) or 36 inches (91.44 cm) from a first edge of the first pair of parallel sides; and the kingpin is located along the centerline of the trailer at a location between the additional kingpin and the second edge of the first pair of parallel sides.

According to an aspect, the trailer comprises foldable support legs which, when coupled to the tractor, the tractor controls, such that during coupling of the tractor and the trailer the tractor commands the foldable support legs to a raised position, and upon completing operation the tractor commands the foldable support legs to a lowered position.

According to an aspect, during the coupling of the tractor and the trailer, the tractor raises suspension of the trailer.

According to an aspect, the trailer includes air brakes; and an air compressor which provides air to the air brakes; wherein the tractor controls operation of the air compressor.

According to an aspect, the tractor controls operation of the air compressor via wireless communications.

### BRIEF DESCRIPTION OF THE DRAWINGS

FIG. 1 illustrates a conventional tractor-trailer combination;

FIG. 2 illustrates a first exemplary embodiment of a tractor-trailer combination where the tractor fits entirely beneath the trailer;

FIG. 3 illustrates a second exemplary embodiment of a tractor-trailer combination where the tractor fits entirely beneath the trailer;

FIG. 4 illustrates an example of the trailer support legs being in a raised position;

FIG. 5 illustrates an example of the trailer support legs being in a support position; and

FIG. 6 illustrates an example computer system.

### DETAILED DESCRIPTION

Various embodiments of the disclosure are described in detail below. While specific implementations are described, it should be understood that this is done for illustration purposes only. Other components and configurations may be used without parting from the spirit and scope of the disclosure.

Tractor-trailer vehicle systems configured as disclosed herein include an autonomous tractor dimensioned such that the entire autonomous tractor is maneuverable into the space under the trailer, the autonomous tractor being operable to tow the trailer when facing forwardly and/or when facing rearwardly. Systems configured as disclosed herein can, in some configurations, connect via a fifth wheel/kingpin connection, and the resulting articulated vehicle can be used for highway transport. By having an autonomous tractor connected to one or more trailers, where the autonomous tractor fits entirely beneath the trailer (or the first trailer, if there are multiple trailers), the maneuverability of the articulated vehicle is increased, and can also improve aerodynamics if, for example, the front section of the trailer has an aerodynamic nose cone.

In some configurations, the trailer can have deployable supports to support the trailer upon disconnection of the autonomous tractor from the trailer. The folding/lowering of the supports can be controlled by the tractor communicating to the trailer. For example, upon connecting to the trailer, the autonomous tractor can send a signal to the trailer indicating that the autonomous tractor is fully connected and is ready to move, and that the trailer should raise the supports. Upon arriving at a destination, the autonomous tractor can send a signal to the trailer indicating to lower the supports. Once the supports are deployed (such that the weight of the trailer is supported by the supports), the autonomous tractor can disconnect from the trailer and leave the trailer. The communications between the autonomous tractor and the trailer can, for example, be done via wireless communications (e.g., radio frequency (RF), Bluetooth, near field communication (NFC), etc.). In some configurations, the tractor air system can provide the power to raise/lower the supports and/or control the brakes of the trailer.

Preferably, the air systems of the tractor and trailer are connected, with the tractor-trailer system further including an automatically engaging and disengaging pneumatic connection between the autonomous tractor and trailer. For example, the trailer can contain a pneumatic connector, which will allow the autonomous tractor to couple and decouple with air brake lines of the trailer to control the trailer's air brakes. This pneumatic connector can further include a retractable air cable that keeps slack in the line controlled so as not to allow the air cable line to hang on other components or become twisted up in the combined tractor-trailer unit. In this manner the pneumatic brakes of the trailer can be controlled by the autonomous tractor. This pneumatic connection interface will preferably be placed behind the king pin from the perspective of the autonomous trailer, such that the pneumatic connection is not be damaged when the fifth wheel of the tractor is coupling to the kingpin of the trailer.

An alternative configuration to the pneumatic air supply being provided by the tractor is that the trailer itself can have an air compressor, which can be controlled by wireless communications with the autonomous tractor, such that the autonomous trailer which will release the brakes and allow operation by controlling the trailer's air compressor and/or air supply. If the trailer has its own air compressor, power for that air compressor can come from the autonomous tractor or the power for the air compressor can come from a battery on the trailer, where the battery is charged by the autonomous tractor.

The position of the kingpin on trailers configured as disclosed herein can vary based on whether the trailer is configured to operate exclusively with autonomous tractors and manual tractors and/or based on whether the trailer is configured to operate with autonomous tractors which face forwardly and/or rearwardly. For example, if a standard (manual) tractor/trailer combination has the kingpin located along a centerline of the trailer at 30 inches (76.2 cm) or 36 inches (91.44 cm) from an edge of the trailer, an autonomous tractor may be able to couple to the trailer facing rearwardly. In another configuration, the trailer may have a kingpin located at 60 inches (152.4 cm) or 90 inches (228.6 cm) from the edge of the trailer, and the autonomous tractor may be able to couple to the trailer facing forwardly. In yet another configuration, the trailer may have kingpins located at both the 30 inch (76.2 cm) and 60 inch (152.4 cm) locations, such that it can couple to manual tractors, autonomous tractors facing rearwardly, and autonomous tractors facing forwardly. It is noted that the kingpin distances provided are exemplary only, and that other distances for the kingpin from the edge of the trailer may also be used within the scope of this invention.

An example articulated vehicle, configured as disclosed herein, can include: a tractor configured to operate in an autonomous mode; and a trailer removably coupled to the tractor, wherein: the trailer has a kingpin for coupling to the tractor; the tractor, when coupled to the trailer via the kingpin, and aligned with the trailer, fits entirely beneath the trailer; and the tractor is operable to tow the trailer when removably coupled to the trailer.

In some configurations of the example articulated vehicle, the tractor can be configured to tow the trailer when facing in a forward direction and when facing in a rearward direction.

In some configurations of the example articulated vehicle, the example articulated vehicle can further include a pneumatic connection between the tractor and the trailer, the pneumatic connection allowing the tractor to control air brakes of the trailer. In such configurations, the pneumatic connection can include a retractable air cable which maintains a predetermined range of slack.

In some configurations of the example articulated vehicle, the trailer of the articulated vehicle can include: a first pair of parallel sides and a second pair of parallel sides, the first pair of parallel sides each respectively at a right angle to the second pair of parallel sides (i.e., the trailer can have a rectangular form), with tires of the trailer are aligned with the second pair of parallel sides, and the trailer can include the kingpin and at least one additional kingpin, where the additional kingpin is located along a centerline of the trailer at either 30 inches (76.2 cm) or 36 inches (91.44 cm) from a first edge of the first pair of parallel sides, and the kingpin is located along the centerline of the trailer at a location between the additional kingpin and the second edge of the first pair of parallel sides.

In some configurations of the example articulated vehicle, the trailer can include foldable support legs which, when coupled to the tractor, the tractor controls, such that during coupling of the tractor and the trailer the tractor commands the foldable support legs to a raised position, and upon completing operation the tractor commands the foldable support legs to a lowered position. In such configurations, during the coupling of the tractor and the trailer, the tractor can raise the suspension of the trailer.

In some configurations of the example articulated vehicle, the trailer can include an air compressor which provides air to air brakes of the trailer; and the tractor controls operation of the air compressor (via wireless or wired communications).

In some configurations of the example articulated vehicle, the trailer can include a plurality of coupled trailers (e.g., two, three, or four trailers), wherein the tractor is physically coupled to a first trailer within the plurality of coupled trailers.

In some configurations of the example articulated vehicle, the tractor is operable for highway towing of the trailer when removably coupled to the trailer.

The disclosure next turns to the specific examples illustrated in the figures.

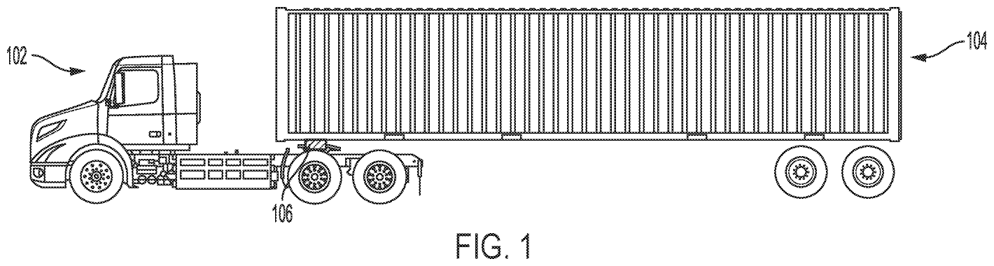

FIG. 1 illustrates a conventional tractor-trailer combination. As illustrated, there is a tractor 102 which is removably coupled to the trailer 104 via a kingpin 106. While the tractor 102 design can vary from that illustrated, in a conventional tractor-trailer the tractor 102 has a cab where human beings can sit while using the vehicle. In the interest of space requirements, comfort, and visibility, this cab is in front of the trailer 104, and sits higher than the bottom edge of the trailer 104.

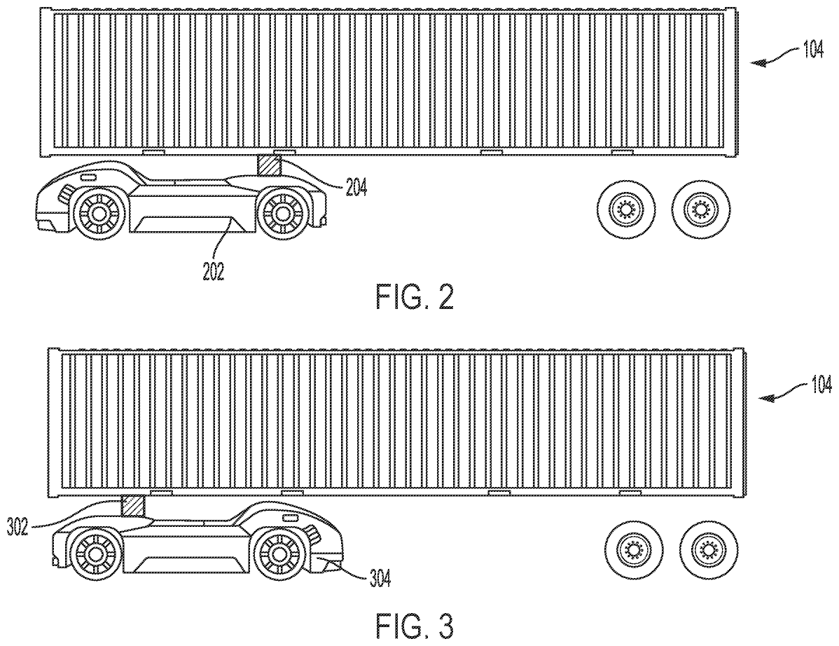

FIG. 2 illustrates a first exemplary embodiment of a tractor-trailer combination where the tractor 202 fits entirely beneath the trailer 104, and the tractor 202 is connected to the trailer 104 via a fifth wheel/kingpin 204 connection. In this example, the tractor 202 is illustrated facing forward (by the hump being near the edge of the trailer 104), and the kingpin 204 is located further back than in the location of the kingpin 106 in FIG. 1. It is noted that the autonomous tractor 202 is exemplary only. In practice, the autonomous tractor 202 may have a flat, curved, or other top/surface configurations, with the fifth wheel connection on one end of the tractor 202 body. In other configurations, the autonomous tractor 202 may have more than one fifth wheel connection—for example, the autonomous tractor 202 may have two fifth wheel connections, either of which may be used to connect to the kingpin 204 depending on specific needs or circumstances.

FIG. 3 illustrates a second exemplary embodiment of a tractor-trailer combination where the autonomous tractor 304 fits entirely beneath the trailer 104, and the autonomous tractor 202 is connected to the trailer 104 via a fifth wheel/kingpin 302 connection. In this example, the tractor 304 is illustrated facing rearwardly (with the tractor 304 hump being in the center of the trailer 104, away from the edge of the trailer 104), and the kingpin 302 is located closer to the edge of the trailer 104 than the kingpin 204 of FIG. 2. The kingpin 302 may be in the same location as the kingpin 106 of FIG. 1, such that the trailer 104 is capable of being pulled by manually driven tractors and/or an autonomous tractor 304. Thus, is some embodiments, the kingpin may be positioned along the trailer at a position such that the entire tractor fits under the trailer.

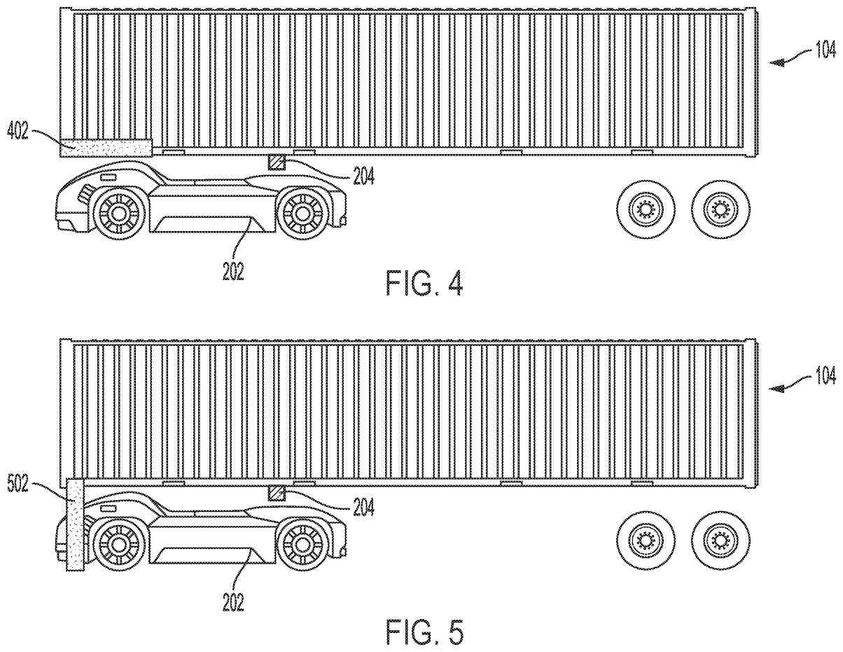

FIG. 4 illustrates an example of the trailer 104 with support legs 402 being in a raised position. As illustrated, the autonomous tractor 202 is located under a single trailer 104 where the kingpin 204 of the trailer 104 would be further back than a standard trailer (such as that illustrated in FIG. 1). In some configurations, when the support leges 402 are raised, they may be stored in the body of the trailer 104, alongside the trailer 104, beneath the trailer 104, or in any other position where they will not interfere with movement of the articulated vehicle.

FIG. 5 illustrates an example of the trailer 104 with support legs 502 being in a support position. As illustrated, the autonomous tractor 202 is located under a single trailer 104 where the kingpin 204 of the trailer 104 would be further back than a standard trailer (such as that illustrated in FIG. 1). The support legs 502 may be on the outside of the tractor 202. Thus, the tractor 202 may maneuverer in between the support legs 502 to engage and disengage with the trailer 104.

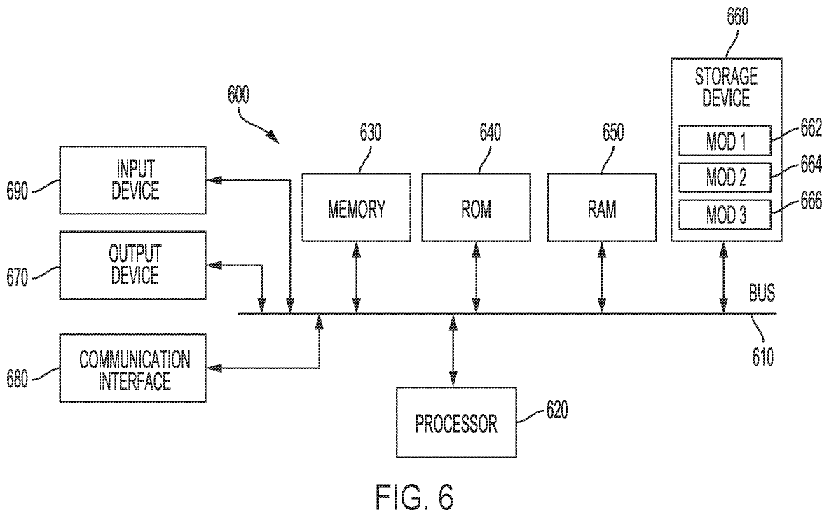

With reference to FIG. 6, an exemplary system includes a general-purpose computing device 600, including a processing unit (CPU or processor) 620 and a system bus 610 that couples various system components including the system memory 630 such as read-only memory (ROM) 640 and random access memory (RAM) 650 to the processor 620. The system 600 can include a cache of high-speed memory connected directly with, in close proximity to, or integrated as part of the processor 620. The system 600 copies data from the memory 630 and/or the storage device 660 to the cache for quick access by the processor 620. In this way, the cache provides a performance boost that avoids processor 620 delays while waiting for data. These and other modules can control or be configured to control the processor 620 to perform various actions. Other system memory 630 may be available for use as well. The memory 630 can include multiple different types of memory with different performance characteristics. It can be appreciated that the disclosure may operate on a computing device 600 with more than one processor 620 or on a group or cluster of computing devices networked together to provide greater processing capability. The processor 620 can include any general purpose processor and a hardware module or software module, such as module 1 662, module 2 664, and module 3 666 stored in storage device 660, configured to control the processor 620 as well as a special-purpose processor where software instructions are incorporated into the actual processor design. The processor 620 may essentially be a completely self-contained computing system, containing multiple cores or processors, a bus, memory controller, cache, etc. A multi-core processor may be symmetric or asymmetric.

The system bus 610 may be any of several types of bus structures including a memory bus or memory controller, a peripheral bus, and a local bus using any of a variety of bus architectures. A basic input/output (BIOS) stored in ROM 640 or the like, may provide the basic routine that helps to transfer information between elements within the computing device 600, such as during start-up. The computing device 600 further includes storage devices 660 such as a hard disk drive, a magnetic disk drive, an optical disk drive, tape drive or the like. The storage device 660 can include software modules 662, 664, 666 for controlling the processor 620. Other hardware or software modules are contemplated. The storage device 660 is connected to the system bus 610 by a drive interface. The drives and the associated computer-readable storage media provide nonvolatile storage of computer-readable instructions, data structures, program modules and other data for the computing device 600. In one aspect, a hardware module that performs a particular function includes the software component stored in a tangible computer-readable storage medium in connection with the necessary hardware components, such as the processor 620, bus 610, display 670, and so forth, to carry out the function. In another aspect, the system can use a processor and computer-readable storage medium to store instructions which, when executed by a processor (e.g., one or more processors), cause the processor to perform a method or other specific actions. The basic components and appropriate variations are contemplated depending on the type of device, such as whether the device 600 is a small, handheld computing device, a desktop computer, or a computer server.

Although the exemplary embodiment described herein employs the hard disk 660, other types of computer-readable media which can store data that are accessible by a computer, such as magnetic cassettes, flash memory cards, digital versatile disks, cartridges, random access memories (RAMs) 650, and read-only memory (ROM) 640, may also be used in the exemplary operating environment. Tangible computer-readable storage media, computer-readable storage devices, or computer-readable memory devices, expressly exclude media such as transitory waves, energy, carrier signals, electromagnetic waves, and signals per se.

To enable user interaction with the computing device 600, an input device 690 represents any number of input mechanisms, such as a microphone for speech, a touch-sensitive screen for gesture or graphical input, keyboard, mouse, motion input, speech and so forth. An output device 670 can also be one or more of a number of output mechanisms known to those of skill in the art. In some instances, multimodal systems enable a user to provide multiple types of input to communicate with the computing device 600. The communications interface 680 generally governs and manages the user input and system output. There is no restriction on operating on any particular hardware arrangement and therefore the basic features here may easily be substituted for improved hardware or firmware arrangements as they are developed.

Use of language such as “at least one of X, Y, and Z,” “at least one of X, Y, or Z,” “at least one or more of X, Y, and Z,” “at least one or more of X, Y, or Z,” “at least one or more of X, Y, and/or Z,” or “at least one of X, Y, and/or Z,” are intended to be inclusive of both a single item (e.g., just X, or just Y, or just Z) and multiple items (e.g., {X and Y}, {X and Z}, {Y and Z}, or {X, Y, and Z}). The phrase “at least one of” and similar phrases are not intended to convey a requirement that each possible item must be present, although each possible item may be present.

The various embodiments described above are provided by way of illustration only and should not be construed to limit the scope of the disclosure. Various modifications and changes may be made to the principles described herein without following the example embodiments and applications illustrated and described herein, and without departing from the spirit and scope of the disclosure.

We claim:

1. An articulated vehicle comprising:
a tractor configured to operate in an autonomous mode; and
a trailer removably coupled to the tractor,
wherein:
the trailer has a kingpin for coupling to the tractor;
the tractor, when coupled to the trailer via the kingpin, and aligned with the trailer, fits entirely beneath the trailer; and
the tractor is operable to tow the trailer when removably coupled to the trailer.

2. The articulated vehicle of claim 1, wherein the tractor is configured to tow the trailer when facing in a forward direction and when facing in a rearward direction.

3. The articulated vehicle of claim 1, further comprising:
a pneumatic connection between the tractor and the trailer,
the pneumatic connection allowing the tractor to control air brakes of the trailer.

4. The articulated vehicle of claim 3, the pneumatic connection comprising a retractable air cable which maintains a predetermined range of slack.

5. The articulated vehicle of claim 1, wherein:
the trailer comprises a first pair of parallel sides and a second pair of parallel sides, the first pair of parallel sides each respectively at a right angle to the second pair of parallel sides;
tires of the trailer are aligned with the second pair of parallel sides;
the trailer comprises the kingpin and at least one additional kingpin;
the additional kingpin is located along a centerline of the trailer at either 30 inches (76.2 cm) or 36 inches (91.44 cm) from a first edge of the first pair of parallel sides; and
the kingpin is located along the centerline of the trailer at a location between the additional kingpin and a second edge of the first pair of parallel sides.

6. The articulated vehicle of claim 1, wherein:
the trailer comprises foldable support legs which, when coupled to the tractor, the tractor controls,
such that during coupling of the tractor and the trailer the tractor commands the foldable support legs to a raised position, and
upon completing operation the tractor commands the foldable support legs to a lowered position.

7. The articulated vehicle of claim 6, wherein during the coupling of the tractor and the trailer, the tractor raises suspension of the trailer.

8. The articulated vehicle of claim 1, wherein:
the trailer comprises an air compressor which provides air to air brakes of the trailer; and
the tractor controls operation of the air compressor.

9. The articulated vehicle of claim 8, wherein the tractor controls operation of the air compressor via wireless communications.

10. The articulated vehicle of claim 1, the trailer comprising a plurality of coupled trailers, wherein the tractor is physically coupled to a first trailer within the plurality of coupled trailers.

11. The articulated vehicle of claim 1, wherein the tractor is operable for highway towing of the trailer when removably coupled to the trailer.

12. A trailer, comprising:
a kingpin for coupling to a tractor; and
at least one pair of wheels;
wherein:
the tractor, when coupled to the trailer via the kingpin, and aligned with the trailer, fits entirely beneath the trailer; and
the tractor is operable for over the highway towing of the trailer when removably coupled to the trailer.

13. The trailer of claim 12, wherein the tractor is configured to tow the trailer when facing in a forward direction and when facing in a rearward direction.

14. The trailer of claim 12, further comprising:
a pneumatic connection between the tractor and the trailer,
the pneumatic connection allowing the tractor to control air brakes of the trailer.

15. The trailer of claim 14, the pneumatic connection comprising a retractable air cable which maintains a predetermined range of slack.

16. The trailer of claim 12, wherein:
the trailer comprises a first pair of parallel sides and a second pair of parallel sides, the first pair of parallel sides each respectively at a right angle to the second pair of parallel sides;
the at least one pair of wheels are aligned with the second pair of parallel sides;
the trailer comprises the kingpin and at least one additional kingpin;
the additional kingpin is located along a centerline of the trailer at either 30 inches (76.2 cm) or 36 inches (91.44 cm) from a first edge of the first pair of parallel sides; and
the kingpin is located along the centerline of the trailer at a location between the additional kingpin and a second edge of the first pair of parallel sides.

17. The trailer of claim 12, wherein:
the trailer comprises foldable support legs which, when coupled to the tractor, the tractor controls,
such that during coupling of the tractor and the trailer the tractor commands the foldable support legs to a raised position, and
upon completing operation the tractor commands the foldable support legs to a lowered position.

18. The trailer of claim 17, wherein during the coupling of the tractor and the trailer, the tractor raises suspension of the trailer.

19. The trailer of claim 12, further comprising:
air brakes; and
an air compressor which provides air to the air brakes; wherein
the tractor controls operation of the air compressor.

20. The trailer of claim 19, wherein the tractor controls operation of the air compressor via wireless communications.
